(19) United States
(12) Patent Application Publication
(10) Pub. No.: US 2023/0127050 A1
(43) Pub. Date: Apr. 27, 2023

(54) METHOD FOR MANUFACTURING A BATTERY, AND CORRESPONDING MANUFACTURING DEVICE

(71) Applicant: AUDI AG, Ingolstadt (DE)

(72) Inventor: Marc GORMANNS, Erlenbach (DE)

(73) Assignee: AUDI AG, Ingolstadt (DE)

(21) Appl. No.: 17/798,717

(22) PCT Filed: Jan. 27, 2021
(86) PCT No.: PCT/EP2021/051834

§ 371 Date: Aug. 10, 2022

(30) Foreign Application Priority Data
Mar. 18, 2020 (DE) 10 2020 107 399.2

(51) Int. Cl. H01M 50/618; H01M 10/04

(52) U.S. Cl. CPC H01M 50/618; H01M 10/0404; H01M 10/653

(57) ABSTRACT

A method for manufacturing a battery, which has a battery housing and at least one cell module, the cell module being introduced into the battery housing to form an intermediate space between a wall of the battery housing and the cell module, and a heat conducting medium then being introduced by an introduction device into the intermediate space. One operating mode is selected from a first operating mode of the introduction device and a second operating mode of the introduction device and is used for introducing the heat conducting medium, with the introduction of the heat conducting medium in the first operating mode occurring with an introduction volume flow set to a preset volume flow and in the second operating mode occurring with an introduction pressure set to a preset pressure.

### FIELD

The invention relates to a method for manufacturing a battery, which has a battery housing and at least one cell module, the cell module being introduced into the battery housing to form an intermediate space between a wall of the battery housing and the cell module, and a heat conducting medium then being introduced into the intermediate space by means of an introduction device. The invention further relates to a corresponding manufacturing device.

### BACKGROUND

The publication DE 10 2018 208 070 A1, for example, is known from the prior art. This document describes a method for manufacturing a battery module device for a motor vehicle, comprising at least the following steps: providing at least one housing element of the battery module device and at least one battery module of the battery module device; mounting the at least one battery module on the at least one housing element, forming at least one intermediate space that extends between an element region of the at least one housing element and the at least one battery module and is delimited and is sealed at least in some regions by at least one sealing element of the battery module device arranged between the element region and the at least one battery module; introducing a heat conducting medium into the at least one intermediate space via at least one filling opening arrangement.

### SUMMARY

It is the object of the invention to propose a method for manufacturing a battery which has advantages over known methods, in particular enabling the heat conducting medium to be introduced into the intermediate space more quickly and at the same time in a process-reliable manner.

According to the invention, this is achieved with a method for manufacturing a battery. It is provided that one operating mode is selected from a first operating mode of the introduction device and a second operating mode of the introduction device and is used for introducing the heat conducting medium, with the introduction of the heat conducting medium in the first operating mode occurring with an introduction volume flow set to a preset volume flow and in the second operating mode with an introduction pressure set to a preset pressure.

The method described is used to manufacture the battery. The battery is for example, a traction battery, which is preferably installed as part of a motor vehicle, but can also be present separately from it. The traction battery is used to temporarily store electrical energy, which is used in particular to drive a traction device or a drive unit of the motor vehicle. The electrical energy stored in the traction battery is thus used to provide a drive element directed at driving the motor vehicle by means of the drive device or the drive unit.

The traction battery has the battery housing and the at least one cell module. The cell module serves to temporarily store the electrical energy. For this purpose, it has at least one battery cell, preferably a plurality of battery cells electrically connected to one another. A receiving compartment is formed in the battery housing, which compartment is provided and formed for receiving the cell module. Preferably, not only one single cell module but several cell modules are arranged in the battery housing. In such a configuration, the battery housing has a compartment which is designed to accommodate a plurality of cell modules. The receiving compartment is bounded by a wall of the battery housing, in particular a bottom wall of the battery housing.

Alternatively, the battery housing can have as many receiving compartments as there are cell modules, with each of the receiving compartments being delimited by the wall of the battery housing, in particular the bottom wall of the battery housing. Provision can be made for the compartments to be separated from one another by partitions of the battery housing. This means that there is one of the partitions of the battery housing between each two of the receiving compartments. When the battery is manufactured, not only is the cell module or the plurality of cell modules arranged in the receiving compartment or in the receiving compartments, but the cell module or the cell modules are also electrically connected.

The receiving compartment is delimited at least in certain regions by the wall of the battery housing. The receiving compartment is preferably bordered by a plurality of walls, one of the walls being designed as a bottom wall, for example, and the other walls as side walls. If the wall of the battery housing is mentioned in the context of this description, the bottom wall is preferably meant. Alternatively, however, one of the side walls can also be used as a wall. It can be provided that support surfaces are formed on the walls, in particular the side walls, which serve to support or fasten the cell module after it has been arranged in the receiving compartment.

For example, the support surfaces are arranged in such a way that the cell module is spaced apart from the wall, in particular from the bottom, of the battery structure after it has been arranged in the receiving compartment, while it is supported on the support surfaces. In this way, tolerances in the dimensions of the cell module and the battery housing can be reliably compensated. Provision can be made for the cell module to be supported directly on the support surfaces. However, it can also be provided that a tolerance compensation element is arranged between the cell module and the support surfaces, by means of which manufacturing tolerances of the cell module and/or the battery housing can be compensated.

The support surfaces, if present, for example, are provided on fastening elements which protrude from at least one wall or from walls of the battery housing. The fastening elements are preferably connected to the wall or walls in a cohesive manner, for example glued or welded to them. The cell module, on the other hand, can have support surfaces which, after the cell module has been arranged in the receiving compartment, bear against the support surfaces, in particular planar or flat, so that the cell module is supported in the receiving compartment at a distance from the wall, in particular from the bottom.

In this respect, the cell module does not touch the wall or the bottom and is at most indirectly connected to it, namely via the heat conducting medium. Alternatively, it can be provided that the cell module touches the wall or the bottom only in certain regions. In any case, the heat conducting medium is present between the wall of the battery housing and the cell module. In other words, when the cell module is introduced into the battery housing, the intermediate space is formed, which is delimited on the one hand by the wall of the battery housing and on the other hand by the cell module. Provision can be made for the space away from the wall and the cell module to be closed off at least in regions with the aid of a sealing element in order to prevent the heat conducting medium from escaping from the space. However, this sealing element is purely optional.

For effective cooling of the cell module, it is necessary to create a thermal connection between the cell module and the battery housing. For this purpose, the heat conducting medium is introduced into the battery housing, namely into the intermediate space, during the manufacture of the battery. According to the invention, the battery housing and the cell module are first provided and the cell module is introduced into the battery housing to form the intermediate space. The heat conducting medium is then introduced into the intermediate space, namely in such a way that the heat conducting medium rests against the wall of the battery housing on the one hand and against the cell module on the other hand. In this respect, the heat conducting medium connects the cell module and the battery housing to one another. The introduction of the heat conducting medium into the intermediate space after the cell module has been introduced into the battery housing has the advantage of a cost-effective and resource-efficient manufacturing of the battery.

A multi-component heat conducting medium is used as the heat conducting medium, for example, which consists of at least a first component and a second component. In this case, the first component is, for example, a carrier material and the second component is a filler, with the thermal conductivity of the heat conducting medium being achieved primarily by means of the filler. For this purpose, the filler preferably has a higher thermal conductivity than the carrier material. The heat conducting medium is in the form of a liquid or a paste, for example. The latter is to be understood as meaning a solid-liquid mixture, with the first component being present as a liquid and the second component as a solid, for example. The second component preferably contains or consists of metal particles. The proportion of the second component in the heat conducting medium is particularly preferably at least 50%, at least 60%, at least 70% or at least 80%. As a result, particularly good heat conduction is achieved with the help of the heat conducting medium.

Due to the normal consistency or viscosity of the heat conducting medium, a counter-pressure builds up during the introduction of the heat conducting medium into the intermediate space. This must be limited in order to prevent damage to the battery housing and/or the cell module due to the force exerted on them by the heat conducting medium. Provision can therefore be made to limit the speed at which the heat conducting medium is introduced, ie the throughput of the heat conducting medium, to a value which ensures over the entire introduction process that the pressure occurring in the intermediate space is not exceeded. However, this leads to a comparatively slow introduction of the heat conducting medium and accordingly to a time-consuming manufacturing process for the battery.

In order to accelerate the introduction of the heat conducting medium, the introduction device should therefore be operable in different operating modes, namely in the first operating mode and the second operating mode. One operating mode is selected from the first operating mode and the second operating mode and set on the introduction device. The selected operating mode is then used to introduce the heat conducting medium. For example, provision is made here for both operating modes to be used at times during the introduction process of the heat conducting medium.

The operating modes differ with regard to an introduction parameter, which is set to a preset value during introduction. In the first operating mode, the introduction volume flow is used as the introduction parameter and the preset volume flow as the preset value. In the second operating mode, the introduction pressure serves as the introduction parameter and the preset pressure as the preset value. Thus, while in the first operating mode the introduction volume flow of the heat conducting medium is adjusted, in the second operating mode the introduction pressure is adjusted. The introduction volume flow is to be understood as the volume per unit of time with which the heat conducting medium is introduced into the intermediate space by means of the introduction device. The introduction pressure is the pressure of the heat conducting medium, for example in the intermediate space or alternatively in the introduction device.

Setting the introduction parameter to the preset value should preferably be understood to mean that the introduction parameter is regulated to the preset value. The introduction parameter is set to the preset value, for example, by appropriately setting a conveying means, with which the heat conducting medium is conveyed through the introduction device and introduced into the intermediate space. The conveying means is for example in the form of a pump or the like. The conveying means is preferably regulated in such a way that the introduction parameter corresponds to the preset value, ie the introduction volume flow corresponds to the preset volume flow in the first operating mode and the introduction pressure corresponds to the preset pressure in the second operating mode.

In the first operating mode, for example, a comparatively large amount of heat conducting medium can be introduced into the intermediate space particularly quickly and efficiently. In the second operating mode, on the other hand, the introduction pressure is limited, so that damage to the battery, in particular to the battery housing and/or the cell module, is reliably prevented. Overall, the method thus enables the battery to be manufactured in a particularly reliable manner.

A development of the invention provides that at the beginning of the introduction, the first operating mode is used first and then a switch is made to the second operating mode. It has already been explained above that the first operating mode enables the heat conducting medium to be introduced particularly quickly, at least a large part of the heat conducting medium or the entire heat conducting medium. Since the intermediate space is still empty or at least largely empty at the beginning of the introduction, there is no need to limit the introduction pressure because the pressure prevailing in the intermediate space is still low. The pressure present in the intermediate space only increases when the intermediate space is already partially filled with the heat conducting medium as a result of the introduction of the heat conducting medium into the intermediate space in the first operating mode.

Correspondingly, after the introduction of a specific amount of heat conducting medium in the first operating mode, the system switches to the second operating mode in order to prevent an excessive increase in pressure. Switching from the first operating mode to the second operating mode can take place, for example, after a certain period of time, which is determined from empirical values, or after the introduction of a predetermined quantity of heat conducting medium. By using both the first operating mode and the second operating mode, the heat conducting medium can be introduced particularly quickly into the intermediate space, with damage to the battery being reliably avoided at the same time.

A development of the invention provides that the operating mode is selected as a function of a pressure of the heat conducting medium. The pressure of the heat conducting medium is preferably measured. Thus, it can always be reliably prevented that the pressure exceeds the allowable pressure. For example, provision is made for initially using the first operating mode for introducing the heat conducting medium into the intermediate space. During the introduction in the first operating mode, the pressure of the heat conducting medium is constantly monitored. If the pressure exceeds a specific limit value, the system switches from the first operating mode to the second operating mode and the introduction is then carried out in the second operating mode.

The limit value, which is switched to the second operating mode when it is reached or exceeded, corresponds, for example, to the preset pressure. In other words, the introduction is carried out until the preset pressure is reached by the pressure in the first operating mode. It is only when the pressure reaches the preset pressure that the system switches to the second operating mode, so that the introduction pressure is subsequently set to the preset pressure, in particular is limited upwards to the preset pressure. The introduction pressure preferably corresponds to the measured pressure. In other words, the introduction pressure is measured, in particular by means of a corresponding sensor. This achieves the advantages described above.

A further development of the invention provides that the pressure of the heat conducting medium is measured in the intermediate space or upstream of an outlet opening of the introduction device. The introduction device has the outlet opening through which the heat conducting medium exits the introduction device during introduction and enters the intermediate space. In this respect, the outlet opening represents a point of the introduction device that is located furthest downstream.

The pressure of the heat conducting medium is particularly preferably measured directly in the intermediate space in order to enable the pressure to be determined particularly reliably. For example, a pressure sensor is arranged for this purpose next to the outlet opening on the introduction device. Alternatively, however, the pressure can also be measured upstream of the outlet opening, ie before the heat conducting medium emerges from the introduction device. In this case, the point is preferably selected in such a way that the measured pressure corresponds or at least approximately corresponds to the pressure present in the intermediate space. This achieves a high level of process reliability.

A further development of the invention provides that the outlet opening is fluidically connected to a static mixer and the pressure is measured downstream of the static mixer in terms of flow, in particular between the static mixer and the outlet opening. The introduction device is designed in such a way that the heat conducting medium first runs through the static mixer before it emerges from the outlet opening.

The static mixer is to be understood as a device in which mixing of the heat conducting medium is achieved solely by the flow movement of the heat conducting medium. The static mixer is preferably designed in such a way that the heat conducting medium is divided into a plurality of heat conducting medium streams, which are subsequently combined again. The merging results in a mixing of the heat conducting medium. The homogeneity of the heat conducting medium is improved with the aid of the static mixer.

The outlet opening of the introduction device is located downstream of the static mixer. In order to obtain an approximation of the pressure present in the intermediate space which is as accurate as possible, the pressure is fluidically measured downstream of the static mixer. Particularly preferably, the pressure is measured between the static mixer and the outlet opening. As a result, switching between the two operating modes and setting the preset pressure are possible in a particularly reliable manner.

A development of the invention provides that the first operating mode is used when the measured pressure is below a limit value and the second operating mode is used when the pressure corresponds at least to the limit value. In other words, the first operating mode is used to introduce the heat conducting medium into the intermediate space as long as the pressure is less than the limit value.

If the pressure reaches or exceeds the limit value, a switch is made from the first operating mode to the second operating mode in order to prevent the pressure from rising further. This achieves the already described high level of process reliability when manufacturing the battery. Of curve, provision can also be made to switch back from the second operating mode to the first operating mode as soon as the pressure falls below the limit value again. As a result, the heat conducting medium can be introduced particularly quickly.

A further development of the invention provides that the first operating mode is initially used continuously during the introduction and the second operating mode is used continuously from the time the measured pressure reaches or exceeds the limit value until the end of the introduction. At the beginning of the introduction, the first operating mode is therefore initially set. The first operating mode is used to introduce the heat transfer medium into the intermediate space until the measured pressure reaches or exceeds the limit value. If this is the case, the first operating mode is switched to the second operating mode and the introduction is continued in the second operating mode.

In contrast to the explanations above, however, there is no switching back to the first operating mode if the pressure is again lower than the limit value. Rather, the heat conducting medium is put through until the end of the introduction in the second operating mode. The end of the introduction is reached, for example, as soon as a certain amount of heat conducting medium, in particular a certain volume of the heat conducting medium, has been introduced into the intermediate space by means of the introduction device during the introduction.

Alternatively, it can also be provided that the end of the introduction is reached as soon as the introduction volume flow, with which the heat conducting medium is introduced into the intermediate space, falls below a volume flow limit value in the second operating mode due to the setting of the introduction pressure to the preset pressure. In this case, it is assumed that the intermediate space is essentially filled and that no further heat conducting medium has to be introduced into it. In any case, with the procedure described, a high level of process reliability is achieved when manufacturing the battery.

A further development of the invention provides that the introduction in the first operating mode takes place with a higher introduction volume flow than in the second operating mode. This means that at the beginning of the introduction, the highest introduction volume flow over the entire introduction is present. For example, the preset volume flow for the first operating mode is selected such that at least 25%, at least 50% or at least 75% of the heat conducting medium to be introduced into the intermediate space is introduced before switching from the first operating mode to the second operating mode. Correspondingly, a particularly rapid introduction of the heat conducting medium into the intermediate space is achieved.

The invention also relates to a manufacturing device for manufacturing a battery having a battery housing and at least one cell module, in particular for carrying out the method according to the statements made within the scope of this description, the manufacturing device being provided and designed for the purpose of introducing the cell module in the battery housing by forming an intermediate space between a wall of the battery housing and the cell module and subsequently introduce a heat conducting medium into the intermediate space by means of an introduction device.

The manufacturing device is also provided and configured to select one operating mode from a first operating mode of the introduction device and a second operating mode of the introduction device and to use it for introducing the heat conducting medium, with the introduction of the heat conducting medium in the first operating mode occurring with an introduction volume flow set to a preset volume flow and in the second operating mode with an introduction pressure set to a preset pressure.

Reference has already been made to the advantages of such a configuration of the manufacturing device or such a procedure. Both the manufacturing device and the method for operating it can be further developed according to the statements made within the scope of this description, so that reference is made to them in this respect.

A development of the invention provides that a pressure sensor for measuring a pressure of the heat conducting medium is present between a static mixer and an outlet opening through which the heat conducting medium exits for introduction into the intermediate space. Reference has already been made to the static mixer and the outlet opening and their fluidic arrangement relative to one another.

In terms of flow, the pressure sensor is arranged between the static mixer and the outlet opening. For example, it is part of a component arrangement which can be removed from the introduction device and replaced separately from the static mixer and the outlet opening. In addition to the pressure sensor, the component arrangement can also include the static mixer, so that it is possible to remove and replace the static mixer and the pressure sensor together. For example, such a removal is carried out as part of a replacement of the static mixer or the sensor.

### BRIEF DESCRIPTION OF THE FIGURES

The invention is explained in more detail below with reference to the exemplary embodiments illustrated in the drawing, without the invention being restricted. In particular:

FIG. 1 shows a schematic representation of a manufacturing device for manufacturing a battery having a battery housing and at least one cell module, and

FIG. 2 shows a diagram in which a volume flow and a pressure of a heat conducting medium introduced into the battery by means of an introduction device are plotted over time.

### DETAILED DESCRIPTION

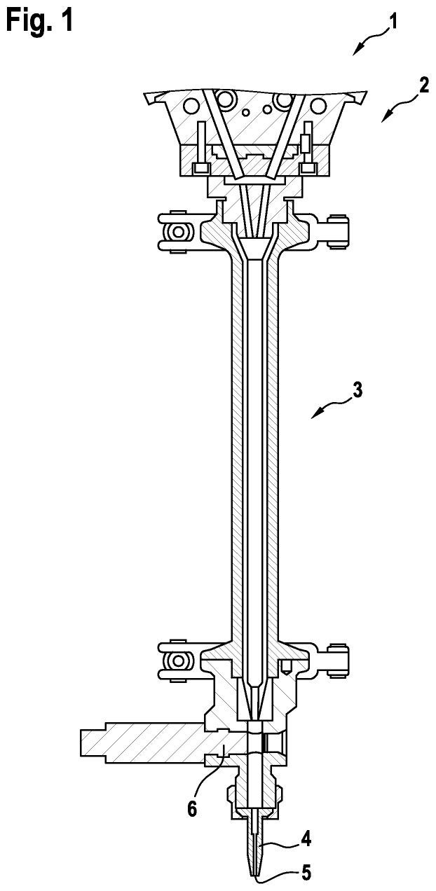

FIG. 1 shows a schematic representation of a manufacturing device 1 which is used to manufacture a battery which has a battery housing and at least one cell module. In particular, an introduction device 2 of the manufacturing device 1 is shown, by means of which a heat conducting medium can be introduced into the battery. More specifically, the battery has an intermediate space formed by introducing the cell module into the battery case. The intermediate space is between a wall of the battery case and the cell module.

The introduction device 2 is used to introduce a heat conducting medium into this intermediate space. Only part of the introduction device 2 is shown here, namely a static mixer 3 and a nozzle 4, the nozzle 4 having an outlet opening 5 at the end. The heat conducting medium is discharged through the outlet opening 5 for introduction into the intermediate space. In terms of flow, there is a pressure sensor 6 between the static mixer 3 and the nozzle 4, by means of which the pressure of the heat conducting medium can be determined at this point.

Provision is now made for the introduction device 2 to be operable in different operating modes, namely at least in a first operating mode and a second operating mode. In the first operating mode, the introduction of the heat conducting medium into the intermediate space is carried out with an introduction volume flow set to a preset volume flow. In the second operating mode, on the other hand, the heat conducting medium is introduced with an introduction pressure set to a preset pressure.

This ensures that, despite rapid introduction of the heat conducting medium into the intermediate space, a permissible pressure of the heat conducting medium in the intermediate space is not exceeded, so that damage to the battery is reliably avoided. The introduction volume flow is, for example, at least 1 cm³/s and at most 15 cm³/s, for example at least 2 cm³/s and at most 10 cm³/s, particularly preferably at least 4 cm³/s and at most 9 cm³/s. A pressure of at least 2 bar and at most 10 bar, at least 4 bar and at most 8 bar or approximately or exactly 4 bar or 6 bar is used as the preset pressure.

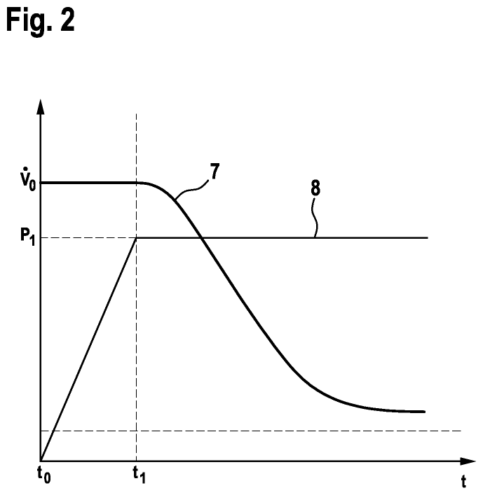

FIG. 2 shows a diagram in which curves 7 and 8 are shown over time t. The curve 7 shows the volume flow V of the heat conducting medium and the curve 8 the pressure, which is measured by the pressure sensor 6. The measured pressure p is preferably set equal to or corresponds to the introduction pressure. It is clear that at the beginning of the introduction, the introduction takes place with a comparatively high volume flow Vo. First, the measured pressure p is low. However, starting from time t₀, it increases until, at time t₁, it reaches a pressure p₁, which is used as a limit value for switching between the first operating mode and the second operating mode.

At time t₁, there is a switchover from the first operating mode to the second operating mode, and the heat conducting medium is then introduced in the second operating mode. In this mode, the introduction pressure corresponding to the measured pressure is set to the preset pressure, which corresponds to the limit value. From this it follows that the pressure remains constant after time t₁, whereas the volume flow decreases steadily.

The introduction of the heat conducting medium in the second operating mode is carried out until the desired amount of heat conducting medium has been introduced into the intermediate space. The procedure described using the manufacturing device 1 shown has the advantage that an extremely rapid introduction of the heat conducting medium into the intermediate space is ensured, while at the same time damage to the battery to be manufactured is reliably avoided.

### REFERENCE LIST

1 manufacturing device
2 introduction device
3 static mixer
4 nozzle
5 outlet opening
6 pressure sensor
7 curve
8 curve

1-10. (canceled)

11. A method for manufacturing a battery that has a battery housing and at least one cell module, wherein the cell module is introduced into the battery housing to form an intermediate space between a wall of the battery housing and the cell module, and a heat conducting medium is then introduced into the intermediate space by an introduction device, wherein one operating mode is selected from a first operating mode of the introduction device and a second operating mode of the introduction device and is used for introducing the heat conducting medium, with the introduction of the heat conducting medium in the first operating mode is carried out with a volumetric flow rate set to a preset introduction volume flow and in the second operating mode with an introduction pressure set to a preset pressure.

12. The method of claim 11, wherein at the beginning of the introduction of the heat conducting medium, the first operating mode is used and then switched to the second operating mode.

13. The method of claim 11, wherein the selection of the operating mode is carried out depending on a pressure of the heat conducting medium.

14. The method of claim 13, wherein the pressure of the heat conducting medium is measured in the intermediate space or upstream of an outlet opening of the introduction device.

15. The method according to claim 14, wherein the outlet opening is fluidically connected to a static mixer and the pressure is measured fluidically downstream of the static mixer.

16. The method of claim 14, wherein the first operating mode is used when the measured pressure is below a limit value and the second operating mode is used when the pressure at least corresponds to the limit value.

17. The method of claim 16, wherein the first operating mode is used continuously during the introduction and the second operating mode is used continuously from introduction or exceeding of the limit value by the measured pressure until the end of the introduction.

18. The method of claim 11, wherein the introduction in the first operating mode takes place with a higher introduction volume flow than in the second operating mode.

19. A manufacturing device for manufacturing a battery having a battery housing and at least one cell module, wherein the manufacturing device is provided and designed to introduce the cell module, to form an intermediate space between a wall of the battery housing and the cell module, into the battery housing and then to introduce a heat conducting medium into the intermediate space by an introduction device, wherein the manufacturing device is further provided and designed to select, from a first operating mode of the introduction device and a second operating mode of the introduction device, an operating mode and to use it for introducing the heat conducting medium, the intro-duction of the heat conducting medium in the first operating mode being carried out with an introduction volume flow set to a preset volume flow and in the second operating mode with an introduction pressure set to a preset pressure.

20. The manufacturing device of claim 19, wherein a pressure sensor for measuring a pressure of the heat conducting medium is fluidically arranged be-tween a static mixer and an outlet opening through which the heat con-ducting medium exits for introduction into the intermediate space.

21. The method of claim 12, wherein the selection of the operating mode is carried out depending on a pressure of the heat conducting medium.

22. The method of claim 15, wherein the first operating mode is used when the measured pressure is below a limit value and the second operating mode is used when the pressure at least corresponds to the limit value.

23. The method of claim 12, wherein the introduction in the first operating mode takes place with a higher introduction volume flow than in the second operating mode.

24. The method of claim 13, wherein the introduction in the first operating mode takes place with a higher introduction volume flow than in the second operating mode.

25. The method of claim 14, wherein the introduction in the first operating mode takes place with a higher introduction volume flow than in the second operating mode.

26. The method of claim 15, wherein the introduction in the first operating mode takes place with a higher introduction volume flow than in the second operating mode.

27. The method of claim 16, wherein the introduction in the first operating mode takes place with a higher introduction volume flow than in the second operating mode.

28. The method of claim 17, wherein the introduction in the first operating mode takes place with a higher introduction volume flow than in the second operating mode.
